(19) United States
(12) Patent Application Publication
(10) Pub. No.: US 2011/0145030 A1
(43) Pub. Date: Jun. 16, 2011

(54) Method and system for determining optimal or near optimal product quantities

(76) Inventor: John Michael Allen, Castle Hill (AU)

(21) Appl. No.: 12/657,871

(22) Filed: Jan. 29, 2010

(30) Foreign Application Priority Data
Dec. 10, 2009 (AU) 2009248431

(51) Int. Cl. G06Q 10/00

(52) U.S. Cl. 705/7.12; 705/28

(57) ABSTRACT

A computer-implemented method for determining optimal or near-optimal product order quantities for receipt on one or more predetermined days is disclosed. The method includes: obtaining inventory data for each of a range of products over a predetermined time period including the one or more predetermined days; generating and storing a representation of an Economic Order Quantity (EOQ) curve for each of the range of products using the inventory data, each of the EOQ curve representations generated specifically for one of said one or more predetermined days and each comprising a plurality of data sets each including a product order quantity and an associated cost; and iteratively: selecting products from the range of products and determining potential order quantities for each of the selected products; for each selected product, retrieving the cost associated with the determined potential order quantity of the product from a respective stored EOQ curve representation; determining a total cost for ordering the selected products in the potential order quantities; and storing the currently selected set of products and associated potential order quantities if the total cost is less than a previously determined total cost.

### FIELD OF THE INVENTION

The present invention relates to the determination of optimal or near-optimal quantities of goods or products for purposes of minimising or at least reducing costs relating to transportation, ordering, inventory carrying, etc.

### BACKGROUND

If a container of goods or products to be transported is only partly full then an opportunity may exist to optimally or near-optimally ‘top it up’. The motivation is to efficiently utilise the spare space in the container, thus saving on transportation costs. However, too much product may be ordered in the process, which may lead to excess inventory. The carrying costs of the excess inventory may be significant, and may even be sufficiently high so as to cancel out the benefit of the reduced transportion costs.

In another scenario, customer organisations may be eligible to receive rebates from vendor organisations if product supply target volumes are achieved. Such rebates, which typically arise as the end of supply contracts approach, can be significant and may cause a tendency to over order. In the absence of decision support tools, unsuitable products may be ordered, or products may be ordered in excess of prudent volumes. Once again, the carrying costs of the excess inventory may be sufficiently high so as to cancel out the benefit of such rebates.

In yet another scenario, customer organisations typically stock-up across a range of products prior to a seasonal peak (e.g., Christmas) and vendor organisations may offer discounts if certain order volumes are achieved. While significant benefits in terms of such discounts and ordering and transport cost reductions may be available, products may have to be ordered in volumes that result in excessive inventories. Once again, the carrying costs of the excess inventory may be sufficiently high so as to cancel out the benefit of such discounts and ordering and transport cost reductions.

In yet another scenario, vendors or suppliers may specify a minimum order value (e.g., via a strict minimum order constraint or by setting an order charge which applies until an order value level is reached). Customers are then faced with the problem of deciding the best combination of products to reach the required minimum without incurring excessive carrying costs caused by over ordering one or more products.

In yet another scenario, transportation and/or storage of products may be subject to constraints such as total value, total volume, and total weight. For example, a delivery/service van or intermediate warehouse may impose one or more such constraints.

A need thus exists for methods and systems for determining a selection of products to order and the order quantities of those products, so as to achieve an optimally or near-optimally low overall combination of transport, ordering and carrying costs. The product order quantities may be subject to various constraints such as order value, weight, volume, maximum allowed excess and order values, discount breaks, order quantity incentives, and penalties.

### SUMMARY

An aspect of the present invention provides a computer-implemented method for determining optimal or near-optimal product order quantities for receipt on one or more predetermined days. The method comprises the steps of: obtaining inventory data for each of a range of products over a predetermined time period including the one or more predetermined days; generating and storing a representation of an Economic Order Quantity (EOQ) curve for each of the range of products using the inventory data, each of the EOQ curve representations generated specifically for one of said one or more predetermined days and each comprising a plurality of data sets each including a product order quantity and an associated cost; and iteratively: selecting products from the range of products and determining potential order quantities for each of the selected products; for each selected product, retrieving the cost associated with the determined potential order quantity of the product from a respective stored EOQ curve representation; determining a total cost for ordering the selected products in the potential order quantities; and storing the currently selected set of products and associated potential order quantities if the total cost is less than a previously determined total cost.

The method may comprise the steps of randomly selecting a set of products from the range of products and varying potential order quantities of the randomly selected products; and calculating a new total cost based on the varied order quantities. The method may comprise the further step of evaluating the varied order quantities relative to constraints. The method may comprise the further steps of determining one or more values from the group of values consisting of total order weight, total order volume, and total order value; and evaluating the one or more determined values against one or more constraints to determine feasibility of the currently selected set of products and associated potential order quantities. The method may comprise the further step of interpolating between two of the stored data sets to retrieve the cost associated with the determined potential order quantity of a product from a respective stored EOQ curve representation.

Another aspect of the present invention provides a computer-implemented method for generating a representation of costs associated with inventory quantities of a product on a future event day. The method comprises the steps of: obtaining a projected inventory level of the product for the event day; generating a daily inventory projection for the product from the event day for a predetermined period; determining a total cost associated with maintaining the daily inventory projection of the product over the predetermined period, the total cost comprising inventory ordering costs and inventory carrying costs; determining a first product quantity required to increase the projected inventory level of said product on the event day to a maximum inventory level on the event day; determining a total cost associated with the first product quantity, the total cost comprising inventory ordering costs and inventory carrying costs; selecting a first plurality of product quantities between zero and the first product quantity; selecting a second plurality of product quantities between the first product quantity and a maximum allowable excess inventory for the product; determining a total cost associated with each of the first and second plurality of product quantities, each total cost comprising inventory ordering costs and inventory carrying costs; and storing the total costs associated with each of the first and second plurality of product quantities for later retrieval.

The step of generating a daily inventory projection for the product from the event day for a predetermined period may comprise calculating the product inventory level at the end of each day by adding the quantity of any incoming inventory on the day and subtracting the quantity of any outgoing inventory on the day to/from the opening inventory on the day. The inventory carrying costs may be determined by determining the average inventory level for the product over the predetermined period and multiplying the average inventory level by a carrying cost rate for the predetermined period. The inventory carrying costs may be determined by summing the results of multiplying the daily excess inventory by the daily carrying cost rate.

Further aspects of the present invention provide a computer system comprising a memory for storing data for use by one or more processors and at least one processor coupled to the memory. The at least one processor is programmed to perform the computer-implemented methods described hereinbefore.

Further aspects of the present invention provide a computer program product that comprises a computer readable medium comprising a computer program recorded therein for performing the computer-implemented methods described hereinbefore.

### BRIEF DESCRIPTION OF THE DRAWINGS

Embodiments are described hereinafter, by way of example only, with reference to the accompanying drawings in which:

FIG. 1A is a graphical representation of a supply plan for a product;

FIG. 1B is a graphical representation of the supply plan of FIG. 1A, including a top-up order that results in excess inventory;

FIG. 2 is a graphical representation of an Economic Order Quantity (EOQ) curve for a product;

FIG. 3A is a graphical representation of an EOQ curve of a product that is near the organisation's maximum inventory level for that product;

FIG. 3B is a graphical representation of an EOQ curve of a product that is well below the organisation's maximum inventory level for that product;

FIG. 4 is a flow diagram of a method for determining optimal or near-optimal quantities of products in accordance with an embodiment of the present invention;

FIG. 5A is a graphical representation of a supply plan with static minimum and maximum inventory levels;

FIG. 5B is a graphical representation of a seasonal supply plan with minimum and maximum inventory levels varying from month-to-month;

FIG. 5C is a graphical representation of a seasonal supply plan with minimum and maximum inventory levels varying from day-to-day;

FIG. 6A is a graphical representation of a supply plan for a particular product with a zero top-up order;

FIG. 6B is a graphical representation of a supply plan for a particular product with a non-zero top-up order;

FIG. 7 is a graphical representation of an EOQ curve for a product generated in accordance with an embodiment of the present invention;

FIG. 8 is a flow diagram of a method for generating an EOQ curve for a product in accordance with an embodiment of the present invention;

FIG. 9 is a flow diagram of a method for determining a combination of products and quantities of those products so as to minimise the overall costs of ordering and carrying inventory in accordance with an embodiment of the present invention;

FIG. 10 is a flow diagram of a method for randomly selecting a set of products and changes in order quantities for those products; and

FIGS. 11A and 11B are schematic block diagrams of a general purpose computer system with which embodiments of the present invention can be practised.

### DETAILED DESCRIPTION

Embodiments of the present invention provide methods, systems, and computer program products that can be used to determine optimal or near-optimal quantities of products for the purpose of minimising ordering costs and inventory carrying costs in relation to those products. In one scenario, the combination and quantities of products determined may be useful for “topping-up” a transportation container or warehouse. In other scenarios, the combination and quantities of products determined may be useful for evaluating and/or obtaining supplier rebates and/or discounts.

A supply plan is a projection over a period of time (e.g., 12-24 months) of the minimum (safety) and maximum inventory levels for a product, the projected inventory levels of the product, and the purchase order quantities of the product over the period.

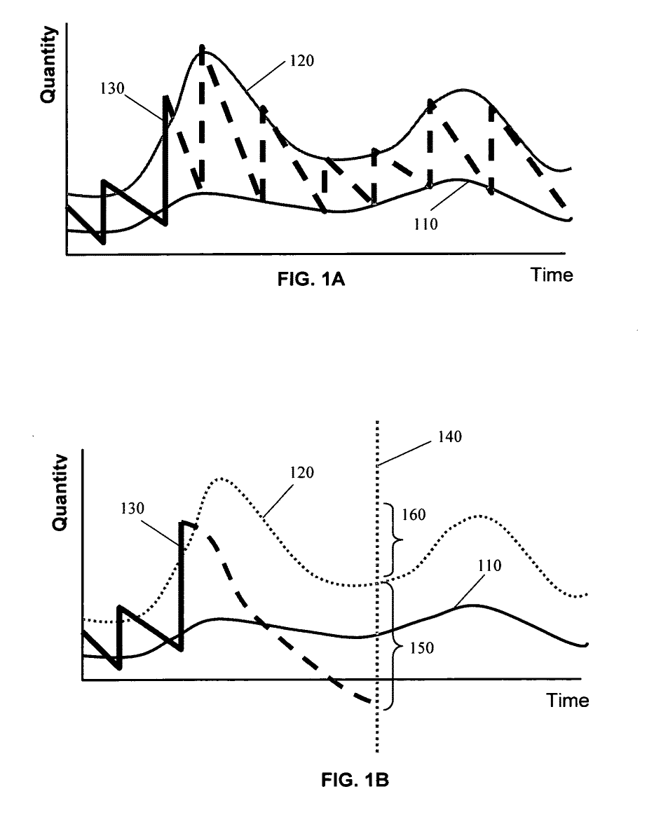

FIG. 1A shows a supply plan for a product in graphical form with product quantity depicted as a function of time. Referring to FIG. 1A, curve 110 depicts a projected minimum or safety inventory level for the product, typically taking factors such as seasonal variation, ordering cost, carrying cost, supplier lead time and reliability into account. Curve 120 depicts a projected maximum inventory level for the product, typically taking factors such as seasonal variation, ordering cost and carrying cost into account. Curve 130 depicts the projected or desired inventory level for the product, typically taking factors such as current inventory level, sales forecasts and incoming purchase orders into account. The vertical portions of curve 130 represent receipt of product orders, which generally act to raise the inventory level of the product back to a maximum inventory level or potentially above the maximun inventory level if safety stock needs is required (e.g., for a future seasonal peak).

FIG. 1B shows the supply plan of FIG. 1A with a top-up order event occurring at a particular time or date 140. A first order quantity 150 of the product will increase the organisation's current inventory level to the organisation's maximum inventory level 120 and a second (additional) order quantity 160 of the product represents excess inventory over and above the maximum inventory level 120 (i.e., a top-up quantity). As stated hereinbefore, excess inventory may incur significant costs (e.g., ordering costs, carrying costs, and transportation costs), which may outweigh any advantages gained by ordering the excess inventory.

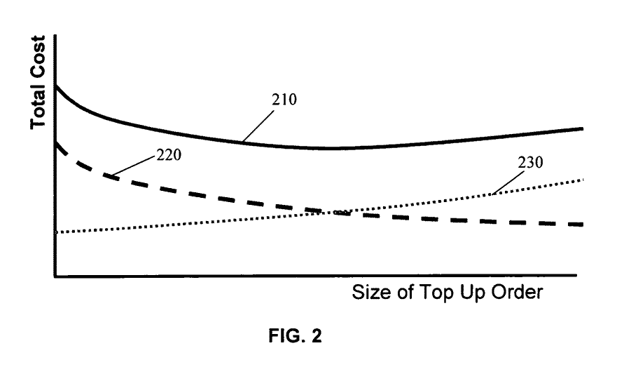

FIG. 2 shows an Economic Order Quantity (EOQ) curve for a product, which comprises a graphical representation of cost as a function of product quantity at a particular point in time.

Referring to FIG. 2, the EOQ curve 210 represents the total costs associated with specified order quantities of the product at a point in time. The EOQ curve 210 comprises a summation of the ordering cost curve 220 and the carrying cost curve 230 as a function of product quantity. Accordingly, the EOQ curve 210 may be used to determine the total costs (i.e., ordering and carrying costs) associated with ordering a specified quantity of the product at a particular point in time. EOQ curves thus provide the costs associated with projected future orders and the carrying costs of future inventory levels out over a planning horizon.

EOQ curves take into account both current and projected inventory levels for a product. In an example scenario in which only a small quantity of a product is ordered at a point in time, a large order might nevertheless be needed very soon thereafter, possibly just before the start of a seasonal high. In such circumstances, it may be more cost effective to place a bigger order initially and suffer a small carrying cost penalty to avoid the costs associated with an additional order. Towards the end of a seasonal high, however, a very different decision might be taken, given the risk of carrying excess inventory through a seasonal low.

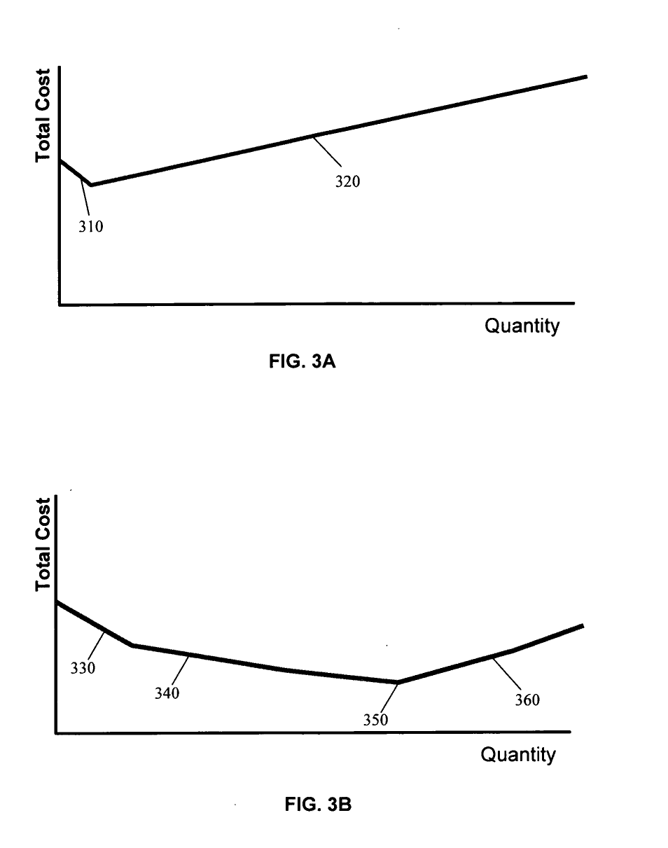

FIG. 3A shows an EOQ curve of a product that is near its maximum inventory level. Referring to FIG. 3A, increasing the order quantity (e.g., ordering inventory excess to current needs) at point 310 may avoid the need for one or more future orders. However, the extra carrying costs incurred by the excess inventory may sufficiently increase the total cost (represented by line segment 320) to negate any benefits conferred by the excess inventory, particularly if the projected inventory level might have been high to begin with. Thus, if a product inventory level is near its maximum inventory level then ordering a large amount of excess inventory to arrive while the inventory level remains high may not be wise.

FIG. 3B shows an EOQ curve of a product that is well below its maximum inventory level. Referring to FIG. 3B, increasing the order quantity (e.g., ordering inventory excess to current needs) along line segments 330 and 340 may avoid the need for one or more future orders. The product quantity at point 350 represents the order quantity required to increase the inventory level back to the maximum inventory level. Increasing the inventory level beyond the maximum inventory level (line segment 360) may raise costs but not so much as to not make a top-up or rebate opportunity worthwhile. Thus, if a product inventory level is near its safety or minimum inventory level and well below its maximum inventory level, the product may be a good candidate for ordering back up to the maximum inventory level, and even above. The EOQ curve generally indicates such a situation.

Depending on forecast sales, expected supplier lead times and other factors, EOQ curves may exhibit a single or multiple minima and they may increase or decrease in cost as the product quantity is increased.

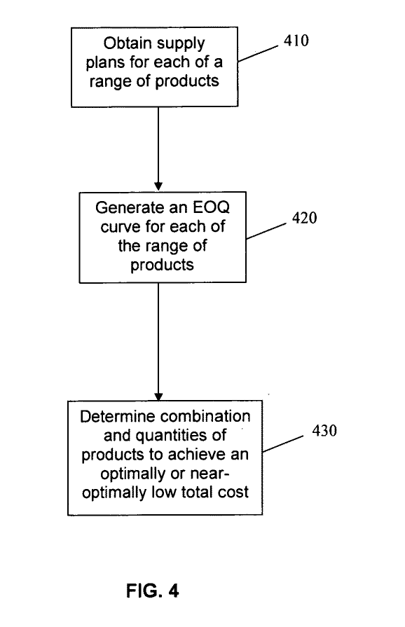

FIG. 4 is a flow diagram of a method for determining optimal or near-optimal quantities of products for receipt on one or more predetermined days (e.g., a top-up or event day) in accordance with an embodiment of the present invention. The quantities determined are useful for the purpose of minimising ordering costs and inventory carrying costs in relation to the selected products. In a supplier rebate or other similar scenario, multiple predetermined (event) days may apply (e.g., when the rebate applies for ordering by a certain date but the ordered products are received over multiple days). In a transportation container top-up scenario, the predetermined day typically corresponds to the top-up day.

Referring to FIG. 4, at step 410, a supply plan is obtained for each of a range of products over a predetermined time period (e.g., a planning horizon). The range of products may, for example, comprise the range of products making up a particular order, the range of products to be transported in a particular container, or the range of products supplied by an organisation. The supply plans typically exclude any excess inventory (i.e., inventory in excess of the organisation's predetermined maximum inventory level). While supply plans may be generated by a variety of methods, a supply plan generally comprises a projection of minimum (safety), maximum and projected inventory levels for a particular product over a predetermined time period or planning horizon. The supply plans obtained may, for example, each comprise a supply plan such as the supply plan depicted in FIG. 1A. An example of generation of such supply plans is also described hereinafter.

At step 420, an EOQ curve (or a representation thereof) is generated for each of the range of products based on data in the supply plan obtained in step 410. The EOQ curves provide total cost (i.e., the sum of ordering cost and carrying cost) as a function of product quantity. The range of the product quantity for an EOQ curve typically spans from zero to a predetermined limit, which may comprise the maximum excess inventory of the product allowed by the organisation. Each EOQ curve is generated specifically for a predetermined (selected) event day, such as a top-up day.

At step 430, a determination is made as to which combination of products in the selected range of products and which quantities of those products will achieve an optimally or near-optimally low total cost. The optimal or near-optimal product combination and related product quantities are iteratively determined as the product quantities are varied according to the respective EOQ curves (generated in step 420) and may be based on various constraints (e.g., constraint quantities that trigger rebates and discounts, and constraint quantities that cause value, volume and weight limits to be violated) and the relative costs. The combination of products and product quantities are determined for the one or more predetermined event days.

### Supply Plans

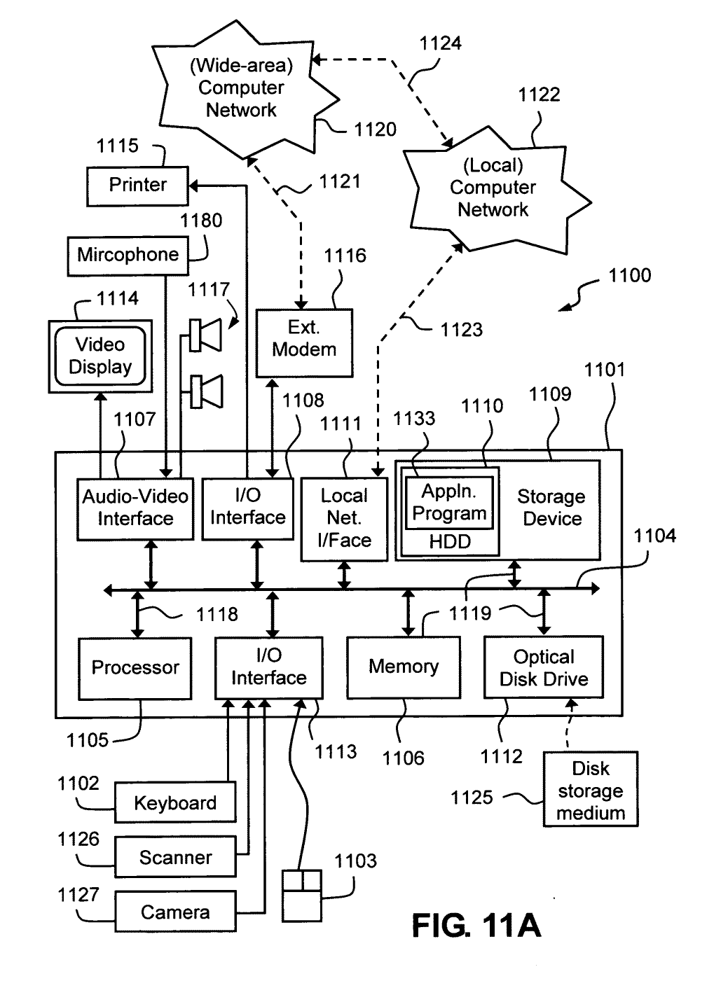

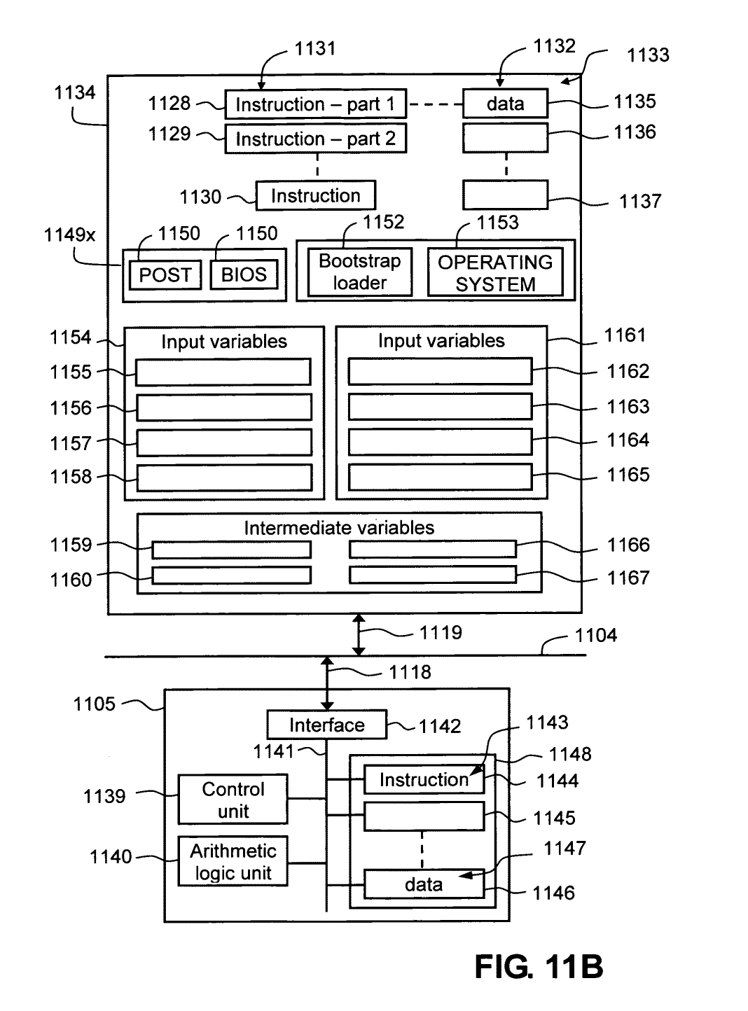

A supply plan for a product over a predetermined time period (e.g., a planning horizon) may be generated as described hereinafter using a computer system such as the computer system 1100 described hereinafter with reference to FIG. 11. Data relating to the product is obtained and loaded into the computer system. Such data typically includes, but is not limited to:
the organisation's current inventory level of the product (e.g., in a warehouse and potentially in any downstream warehouses);
any incoming purchase orders for the product and the associated delivery date/s (which act to increase the inventory level during the predetermined time period or planning horizon);
a sales projection for the product over the predetermined time period or planning horizon, which is typically derived from forecast and forward orders for the product (which act to decrease the inventory level during the predetermined time period or planning horizon); and
supplier lead times and reliability information, including shutdown periods and/or other periods during which the supplier will be unable to provide the product.

The sales projection may include factors such as batch quantities in which the product is commonly sold and working days.

Then, the following information is determined by the computer system using the data above:
daily demand for the product, which varies depending on the time of the week, month, and time relative to the season;
the nominal economic order quantity (EOQ), which varies from day to day based on future demand trends;
the minimum or safety inventory level;
the maximum inventory level; and
the projected inventory level.

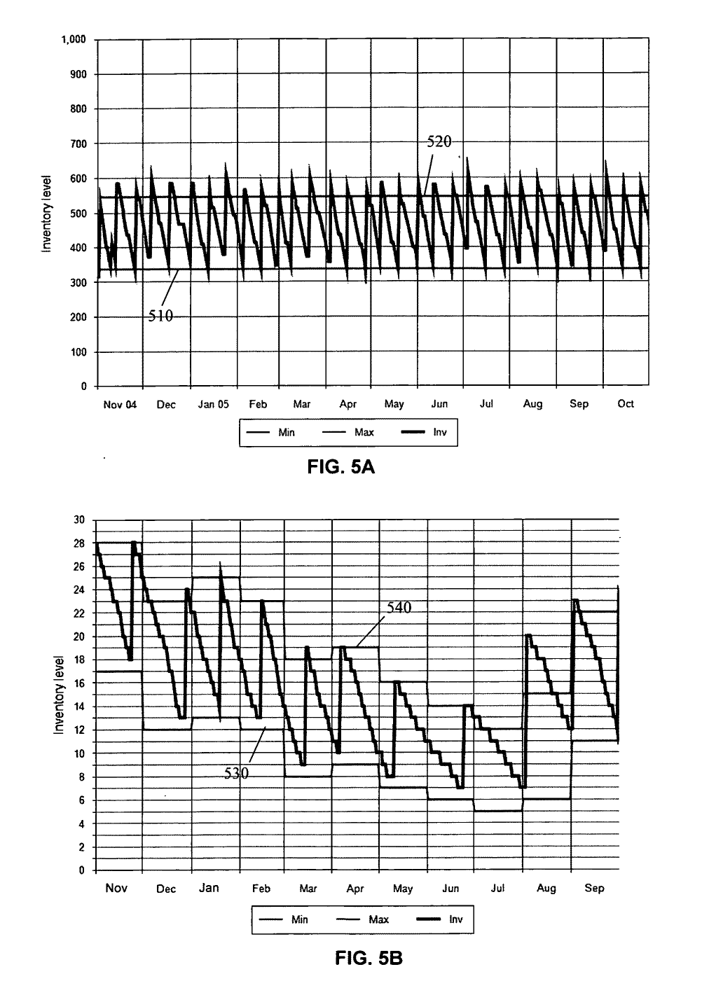

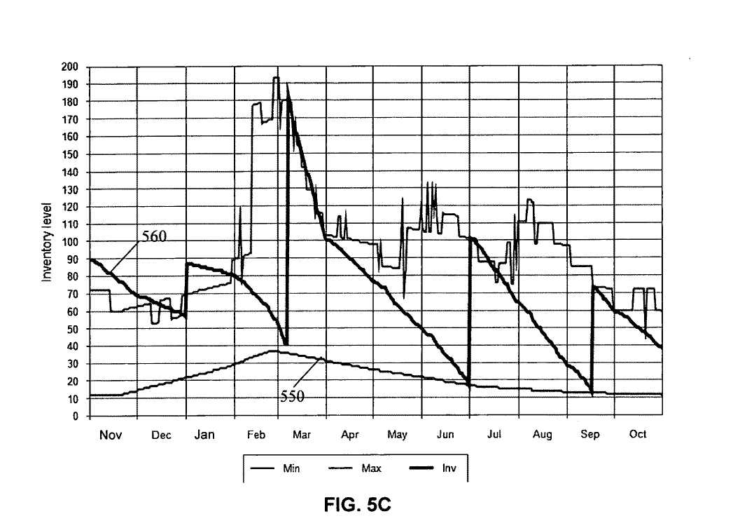

The information above may be graphically represented by the computer system, for example, as depicted in FIGS. 1A and 5A-5C. FIG. 5A is a graphical representation of a simple supply plan with static minimum 510 and maximum 520 inventory levels. FIG. 5B is a graphical representation of a seasonal supply plan with minimum 530 and maximum 540 inventory levels varying from month-to-month. FIG. 5C is a graphical representation of a seasonal supply plan with minimum 550 and maximum 560 inventory levels varying from day-to-day.

The following information may also be gathered or determined for each supply plan (product):
a popularity code or ABC classification for the product, which can be subsequently related to the risk profile of the product (which can be used or determine an absolute maximum level of excess inventory for the product, typically expressed in terms of a number of days or months of sales);
unit cost, weight and volume for the product (which is used to determine the product's unit contribution to overall order value, weight and volume);
the pack size for the product and any applicable packing quantities such as layer or pallet quantities (which can be used to select different order quantities for optimisation and any potential cost reductions associated with particular quantities);
supplier information for the product, including: the name of the supplier, the standard lead time of the product, any minimum line quantity, value, weight or volume applicable to the product, any maximum line quantity, value, weight or volume applicable to the product, and any quantity or value break-points for the product such as order quantity discounts, penalties, costs given different quantity or value levels, etc.; and
the ordering and carrying cost applicable to the product.

The following information may also be gathered or determined for each supplier of products that may be considered for optimisation:
any minimum order value, weight or volume;
any maximum order value, weight or volume; and
any order break-points such as order quantity discounts, penalties, costs given different value levels, etc.

### EOQ Curves

In embodiments described hereinafter, representations of Economic Order Quantity (EOQ) curves for individual products at a particular point in time are generated based on respective supply plans for those products. The EOQ representations may be used to determine optimal or near-optimal quantities of products that minimise total costs associated with ordering and carrying the products. The product quantities determined may then form the basis of an intelligent inventory order.

Products can be grouped into sets with similar risk profiles (e.g., using an ABC classification or a popularity code). For such product groups or sets, the maximum number of months (or days) of excess inventory allowed by the organisation can be specified. This value is typically used to cap or limit the ‘maximum excess inventory’ which will be allowed when determining a ‘top-up’ quantity. If the maximum number of days of excess allowed is zero (i.e., a zero top-up quantity), then the maximum order quantity is that quantity which takes the stock level back up to the maximum inventory level. If, however, the maximum number of days of excess is 30 days, for example, then the order quantity can be increased, but only by an amount such that the excess will be ‘cleared’ within the 30 days. This amount can be calculated by summing the daily demands for the next 30 days—the sum represents the maximum order quantity above the maximum quantity (i.e., the maximum excess inventory) that may be ordered without creating excess above that which is allowed. Similarly, if a maximum of only 14 days of excess were allowed, then the daily demands over the next two weeks would be summed to determine the additional quantity in any top-up order without creating an unacceptable excess quantity of inventory.

The ‘top-up day’ is typically nominated as the day on which the inventory will be received. This may, for example, be the day on which a container becomes available for packing or, alternatively, it may be based on a supplier's lead time. In other embodiments, the top-up day may relate to triggering a rebate or discount based on order quantity. In the latter case, the top-up days for different products may well be different.

In planning for the amount of inventory to be ordered for receipt on the top-up day, the quantity to be ordered is varied in increments (e.g., pack size increments, if applicable) ranging from zero to the maximum excess inventory allowed for the product. The overall cost is then calculated for each increment and stored. The overall cost is a function of the future ordering costs and the inventory carrying costs for the supply plan given the size of the top-up quantity.

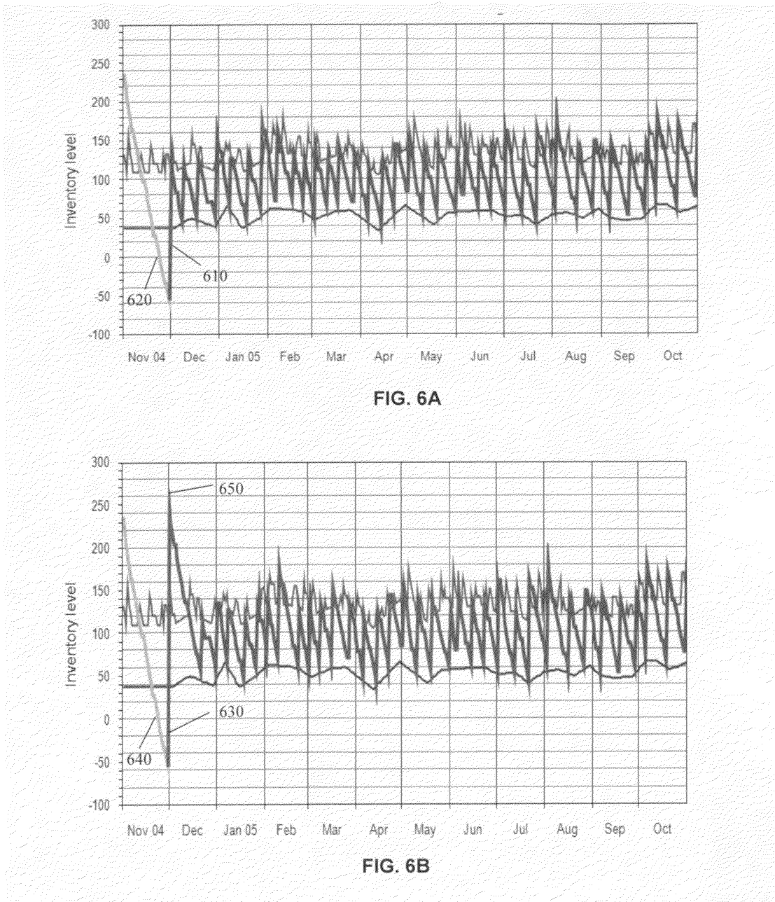

FIG. 6A shows a graphical representation of a supply plan for a particular product with a zero top-up order (i.e., no excess inventory above the maximum inventory level is ordered). The supply plan of FIG. 6A shows inventory level as a function of time, extending over 12 months from November to October the following year. The top-up order 610 is received at the end of the first month (November), being the lead time. A significant backlog 620 is shown during November (hence the negative inventory projection), but then the inventory level is restored to the maximum stock level by the top-up order 610 at the end of November. No excess inventory above the maximum stock level is ordered in this example.

FIG. 6B shows a graphical representation of a supply plan for a particular product with a non-zero top-up order (i.e., an excess quantity of inventory over the maximum inventory level is ordered). The supply plan of FIG. 6B shows inventory level as a function of time, extending over 12 months from November to October the following year. The top-up order 630 is received at the end of the first month (November), being the lead time. A significant backlog 640 is shown during November (hence the negative inventory projection), but then the inventory level is shown to exceed the maximum stock level by a quantity of 120 at the end of November 650. This would cause the inventory level to remain higher for a period of time and would avoid the need for some orders in the shorter term. However, the reduced cost due to a reduced number of orders needs to be balanced against the cost of carrying excess stock, at least for a period of time.

Generation of an EOQ Curve essentially involves evaluating each of a range of possible top-up order quantities, and for each one, calculating:
the resulting inventory and supply plan;
the number and cost of the orders expected to be placed over the planning time horizon, and
the carrying cost of the inventory levels over a predetermined period (e.g., the planning horizon).

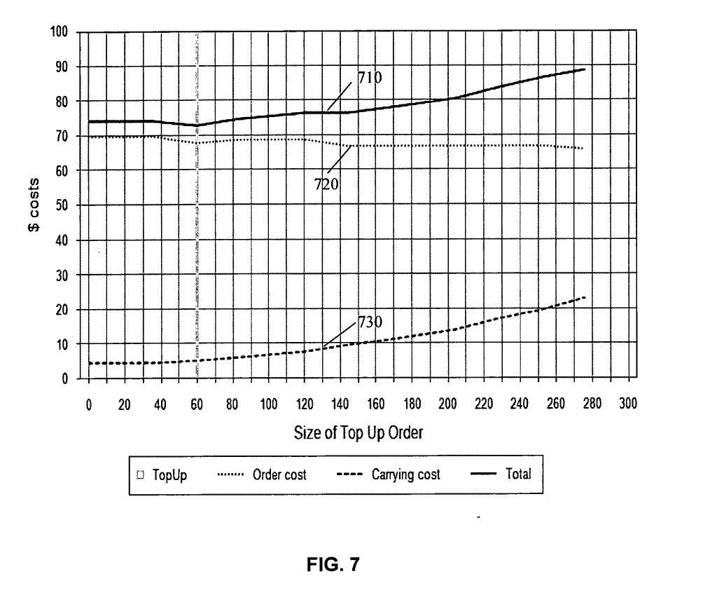

FIG. 7 is a graphical representation of an EOQ Curve generated in accordance with an embodiment of the present invention. The EOQ curve 710 of FIG. 7 shows the total cost for each of the potential top-up quantities for a particular product, ranging between 0 and about 270. A top-up quantity of 60 incurs a total cost of about $73 whereas a top-up quantity of 200 incurs a total cost of about $80. FIG. 7 also (optionally) show the costs of the ordering 720 and inventory carrying 730 components, although it is the total (i.e., sum) of these costs that is important for subsequent optimisation.

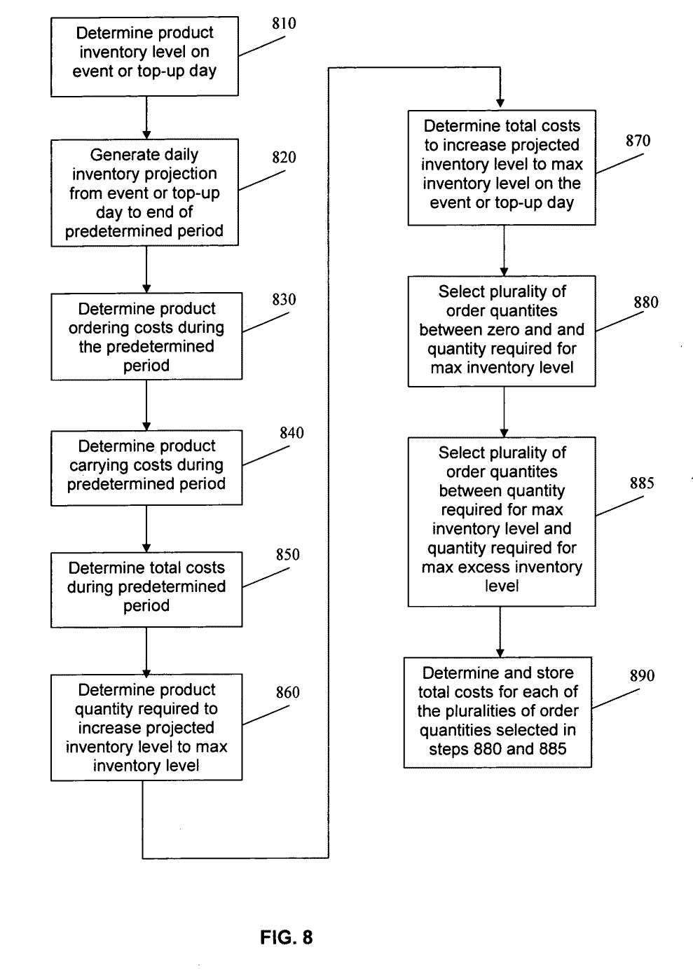

FIG. 8 is a flow diagram of a method for generating an EOQ curve for a product in accordance with an embodiment of the present invention. The method uses data obtained from a product supply plan such as described hereinbefore. The supply plan provides projected inventory from the top-up or event day to the end of a predetermined time period (e.g. a planning horizon). However, those skilled in the art will appreciate that the necessary data may alternatively be obtained from sources other than a supply plan as described hereinbefore, such as a manual or computerized inventory system. The method of FIG. 8 may be practised to perform step 420 of the method described hereinbefore with reference to FIG. 4.

Referring to FIG. 8, at step 810, the inventory level of the product at its top-up day is determined from the product supply plan.

At step 820, a daily product inventory projection is generated from the product's top-up day to the end of the predetermined time period. For example, the product inventory level may be calculated at the end of each day as: the opening inventory for the day+the quantity of any incoming purchase order of the product during the day−the projected demand for the product during the day. Whenever the projected inventory level for a day goes down to or below the minimum (safety) inventory level, it is assumed that the product will be restocked that day back up to the maximum inventory level required to meet the requirements of the supply plan.

At step 830, the ordering costs for the product during the predetermined time period are determined. The ordering costs may be calculated by multiplying the number of orders (in full or in part) for the product during the predetermined time period by the average cost per order or by summing the ordering costs for each order of the product during the predetermined time period.

At step 840, the carrying cost of the projected inventory levels during the predetermined time period is determined. The carrying cost may be calculated by determining the average inventory level over the predetermined period and multiplying this result by a carrying cost rate for the product. Such a carrying cost rate may be based, for example, on interest rate, inventory storage, and other carrying cost factors. Alternatively, the carrying cost may be calculated as the daily excess inventory (where the projected inventory exceeds the maximum inventory level) multiplied by the daily carrying cost rate and summed over the predetermined period. Either method may be selected depending on the particular inventory policy.

At step 850, the total cost of the projected inventory levels during the predetermined period is determined by summing the ordering costs and carrying costs determined in steps 830 and 840, respectively.

At step 860, the projected inventory level and the maximum inventory level for the product on the top-up day are compared to determine whether a purchase order is required to increase the projected inventory level to meet the maximum inventory level and, if so, the quantity of product required. The quantity of product required may be adjusted in accordance with a product pack size or pallet or layer quantities, if applicable.

At step 870, the supply plan and the inventory projection with a purchase order to increase the inventory level to the maximum inventory level for the product on the top-up day is costed to determine the total associated costs, including ordering costs and carrying costs. This is performed in the same manner as described hereinbefore with reference to steps 830, 840 and 850.

At step 880, a plurality of different order quantities (in pack size multiples, if applicable) are selected between zero (i.e., a zero top-up order) and the purchase order quantity determined in step 860 to take the inventory level to the maximum inventory level.

At step 885, a plurality of different order quantities (again in pack size multiples, or considering pallet or layer quantities, if applicable) are selected between a purchase order quantity required to take the inventory level to the maximum inventory level (as determined in step 860) and a purchase order quantity that would take the inventory level to the maximum excess inventory allowed by the organisation (as described hereinbefore).

At step 890, projected supply plans and inventory projections are generated for each of the different order quantities selected in steps 880 and 885. The number and cost of projected purchase orders, the carrying cost of the projected inventory and the total cost are calculated for each of the different order quantities selected in steps 880 and 885. The total cost values (and the purchase order and carrying cost components) are used to characterise or represent the EOQ curve.

A representation of an EOQ curve for use by a computer system typically comprises a plurality of discrete data sets corresponding to each of the order quantities selected in steps 880 and 885 of the method of FIG. 8. Each of the data sets is stored in the memory of the computer system (e.g., in a matrix structure) and comprises an order quantity and a total cost associated with that order quantity. During optimisation, the cost associated with an order quantity being evaluated can be retrieved from the stored data sets. In cases where the order quantity under evaluation falls between two of the data sets, the computer system interpolates between the data sets. Generation of a representation of an EOQ curve can be sped-up or slowed down by controlling the number of data sets. However, a greater number of stored data sets will result in less interpolation, thus improving the accuracy of the optimal or near-optimal result.

### Determination of Product Order Combination and Quantities

Embodiments of a method are described hereinafter for determining or selecting a combination of products and quantities of those products so as to minimise the overall costs of ordering and carrying inventory or stock, taking into account any cost breaks which might be available for particular order quantities, values, etc. These are effectively benefits (i.e., negative costs).

The overall ordering cost may be determined as follows. Firstly, the ordering cost for each product is determined based on the selected order quantity for that product. The ordering cost for a particular product may be determined by obtaining (e.g., ‘looking up’) the ordering cost for the order quantity being evaluated from the product's associated EOQ curve or representation thereof. The total of the ordering costs across all the products is obtained by summing the ordering costs for each product. To this is added any costs or benefits arising from ‘break type’ constraints. For example, an incentive comprising a rebate or an increased discount level for ordering a target quantity of a product from a supplier will act to reduce the overall ordering cost. Examples of constraints include (but are not limited to):
Minimum order value
A minimum order value may be specified, for example, to reach a rebate level target. This minimum order value may be specified in addition to any minimum order value specified by a supplier as part of its normal terms and conditions.
Maximum order value
A maximum order value may be specified, for example, to reflect a maximum level of employee delegation/authorisation or a purchasing budget.
Maximum and/or minimum order weight
A maximum total weight may be specified, for example, such as constrained by the maximum weight which can be carried in a container or the weight available in a container for a top-up order.
Maximum and/or minimum order volume
A maximum total volume may be specified, for example, such as constrained by the maximum volume which can be carried in a container or the volume available in a container for a top-up order.
Order value breaks
A total order value may be specified for one or more products (e.g., a discount break level), wherein the actual total value of that/those product/s is/are compared to the specified total order value. A penalty may be incurred for actual total value below the specified total order value and a discount may be applied for actual total value above the specified total order value.

The maximum excess product values determined for generation of the EOQ curves (as described hereinbefore) are also effectively constraints but these are taken into account prior to proceeding with optimisation. Other constraints, such as ‘fixing’ to force a particular product into the ‘optimised’ result at a particular order quantity level, may also be specified.

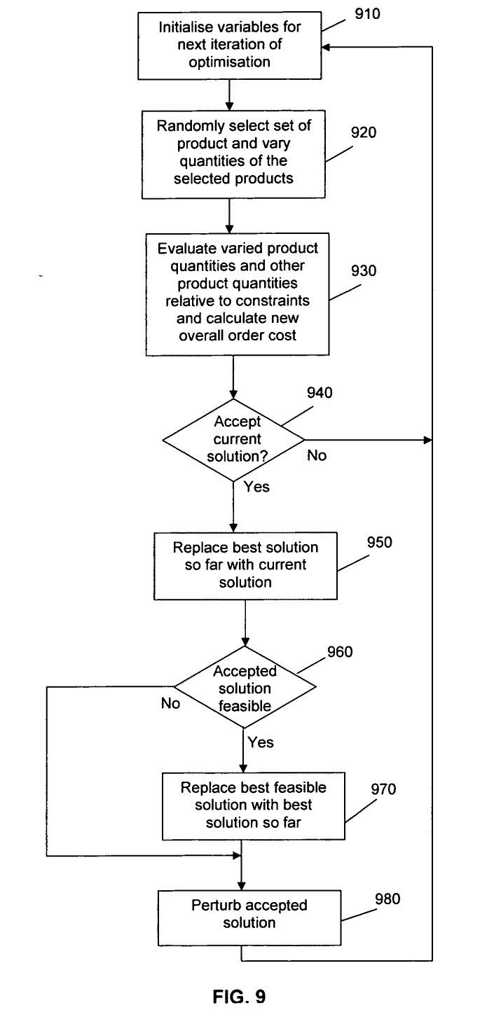

A method is now described hereinafter with reference to FIG. 9 for determining or selecting a combination of products and quantities of those products so as to minimise the overall costs of ordering and carrying inventory or stock, taking into account any cost breaks which might be available for particular order quantities, values, etc. These are effectively benefits (i.e., negative costs). The method described hereinafter with reference to FIG. 9 may be used to practice step 430 of the method described hereinbefore with reference to FIG. 4.

Data variables relating to the products and the optimisation process are prepared and/or initialised prior to commencement of the method of FIG. 9. At the outset, an initial check of all the constraints is made to ensure that a feasible solution is even possible. In particular the following constraints are checked:
Minimum order value
If there are insufficient products which when all topped up to their maxima (as determined from the maximum excess allowed for their EOQ Curves) would not reach the specified overall minimum order value, there is no point in proceeding.
Minimum order weight
Similarly if there is a minimum overall order weight specified, then the weight of the order assuming that all products will be ordered to their maxima is calculated and if the minimum order weight cannot be reached then there is no point in proceeding.
Minimum order volume
In a similar way to weight, the maximum possible order volumes are added and checked against any minimum order volume constraint.

Before the optimisation commences, all the products are prepared as potential candidates. The products may be sorted in terms of the relative slopes of their associated EOQ Curves for later use in the optimisation process to enable certain products increased opportunity to be tested for different options. In addition, a two-way map associating each product with every constraint relating to that product may be generated. The two-way map stores for every product, the constraints which affect that product. Similarly, for each constraint, a list of the products that need to be summed and then checked against that constraint is generated. The two-way map speeds the checking of constraints that are affected or that might have an impact on the feasibility of the solution when the order quantities for different products are evaluated during the optimisation process.

Each product is prepared or initially setup as a zero top-up order, ready for initial costing and feasibility testing of such a solution. All the constraints are then initially evaluated. The value, weight and/or volume of all products affected by a constraint (i.e., all products if an overall constraint, or only certain products if the constraint applies only to certain products or to a certain supplier) have (depending on the type of constraint) is accumulated or totalled for comparison with the constraint value to establish whether a feasible solution is possible. Constraints generally comprise minima, maxima or ‘break type’ constraints that relate to value, weight and/or volume but are not necessarily limited to such. For a minimum constraint, it might need to be determined whether the total value, weight or volume is greater than or equal to the minimum constraint value. For a maximum constraint, it might need to be determined whether the total value, weight or volume is less than or equal to the maximum constraint value. ‘Break type’ constraints are treated differently inasmuch as the costs and benefits of reaching certain, discount breaks or order value breaks are assessed. For example, a minimum order value charge may apply below a minimum value. However, once a certain order level is achieved, a discount may be applied to the order value. The net cost-benefit is added to the overall cost of the solution.

The method described hereinafter with reference to FIG. 9 comprises an iterative optimisation loop that may be terminated after a large number of iterations or if there is no significant improvement in the overall cost results over a predetermined number of iterations and/or a predetermined time period. In a preferred embodiment, the method of FIG. 9 employs the optimisation technique known as ‘Simulated Annealing’. Simulated Annealing is an effective and practical technique which is particularly suitable for optimisation problems that become unmanageable using combinatorial methods as the number of objects or items becomes large. While this technique is unlikely to find the optimum solution, it can often find a very good solution, even in the presence of noisy data.

As the optimisation proceeds, four sets of results are maintained:
A. The best feasible solution accepted so far.
B. The best accepted solution so far but which is not necessarily feasible. For example, an accepted solution may have a lower overall cost but nevertheless violate one or more of the constraints.
C. The potential solution currently under evaluation. This enables new potential solutions to be evaluated without affecting Result A and Result B, as described hereinbefore.
D. The initially proposed solution in which zero (or fixed) top-up values were established for all the products. This solution represents a baseline against which other solutions can be compared in relation to their net overall benefit.

Referring to FIG. 9, data variables relating to the optimisation process and the products to be considered or evaluated are initialised for the next iteration of optimisation, at step 910.

At step 920, a set of the products is randomly selected and order quantities of those products are varied up and/or down to produce a new potential solution for evaluation (Result C, as described hereinbefore). Some products are selected to have their quantities increased, and other products are selected to have their quantities decreased.

At step 930, the varied product order quantities and the order quantities of the other products are evaluated relative to the relevant constraints and a new overall order cost is calculated. Evaluation relative to a constraint typically comprises: (i) determining changes to total value, weight and/or volume resulting from the varied product order quantities; and (ii) comparing the new total/s against the constraint (e.g., minimum, maximum, and/or order value breaks) to assess the feasibility of the constraint and to determine whether any penalties or additional penalties need to be applied due to an order value break type constraint. Overall constraints (i.e., constraints that relate to all of the selected products in combination) and constraints which apply to only certain of the selected products may be separately evaluated. Overall constraints are typically evaluated by comparing the actual total value, weight and/or volume of the combined selected products against minimum and/or maximum limits, as appropriate. In cases where a constraint only applies to certain products, the products may be rapidly identified using the two-way mapping described hereinbefore. This enables faster evaluation and advantageously improves the speed of optimisation.

At decision step 940, a determination is made whether to accept or reject the current (new) potential solution (Result C). If the current potential solution is rejected, the method returns to step 910 to initialise the data variables for the next iteration of optimisation. Alternatively, if the current potential solution is accepted, the method proceeds to step 950. Acceptance or rejection of the current potential solution is performed by comparing the current potential solution (Result C) with the best solution so far, which may not be feasible (Result B). If the overall cost of ordering for the current potential solution is lower than the overall cost of ordering for the best solution so far, the current solution is accepted. Otherwise, if the overall cost of ordering for the current potential solution is higher than the overall cost of ordering for the best solution so far, a probability test may be applied to determine whether the sub-optimal current solution should nevertheless be accepted. The skilled reader will appreciate that such a probability test forms part of the Simulated Annealing technique, whereby the ‘temperature’ of the Simulated Annealing is reduced over time such that only successively smaller increases in cost are deemed to be acceptable. If the overall cost of ordering for the current potential solution is higher than the overall cost of ordering for the best solution so far and is not allowed by the Simulated Annealing probability test, then the current potential solution will be rejected.

At step 950, the best solution so far (Result B) is replaced with the current potential solution (Result C). That is, the product order quantities and other values for Result B are updated or replaced with the varied order quantities and other values determined in steps 920 and 930.

At decision step 960, the overall feasibility of the accepted solution is tested. This comprises checking whether any of the constraints tested in step 930 were violated. As described hereinbefore, a solution accepted in step 940 on the basis of lower overall cost may neverthess violate one or more constaints in relation to one or more products. If none of the constraints are violated, the method proceeds to step 970. If, however, one or more of the constraints are violated, the method bypasses step 970 and proceeds directly to step 980.

At step 970, the best feasible solution accepted so far (Result A) is replaced with the best solution accepted so far (Result B). That is, the product order quantities and other values for Result A are updated/replaced with the varied order quantities and other values determined in steps 920 and 930.

At step 980, the accepted solution is perturbed. An accepted new solution (Result B) is perturbed such that what appears to be a positive movement for the products affected will be continued for further iterations to determine whether new potential solutions (Result C) can quickly improve on the best solution so far (Result B).

Examples of two forms of perturbation used in embodiments of the present invention are now described. The first form comprises perturbing along similar lines to one or more previous iterations. If, for example, one product's order quantity is advantageously being increased and another product's order quantity is advantageously being decreased then, to the extent allowed by the limits for order quantities imposed by the EOQ curves, further increases/decreases in the same direction are attempted until the solution becomes unacceptable. This form of perturbation is effectively predicated on: ‘Looks like we are heading in the right direction. Let's try a bit more in the same direction and see if we can improve still further.’ The second form comprises perturbing up and down. This form of perturbation is useful when attempting to juggle, for example, quantities of a first product versus a second product when a value, weight or volume constraint applies. The quantities may, for example, be increased by one pack size for the first product and decreased by one pack size for the second product.

After perturbation at step 980, the method returns to step 910 to initialise the data variables for next iteration of optimisation.

As discussed hereinbefore, the method may be terminated after a large number of iterations or if no significantly improved solution results over a predetermined number of iterations and/or a predetermined time period. On termination, the set of products and their recommended order quantities can be output to a user.

The existence (or otherwise) of an (A) solution will indicate whether the solution is feasible. If the solution is infeasible (i.e., a (B) solution exists but not an (A) solution), then each constraint is typically reported along with the relevant total (of value, weight or volume) and whether or not the solution is feasible against the constraint.

The (A) solution (or (B) solution if no feasible solution found) may be compared with the (D) solution to establish the net overall benefit (or cost) of following the recommended top-up quantities for each product. This can be used to assess the business case for adopting the solution recommended by the method.

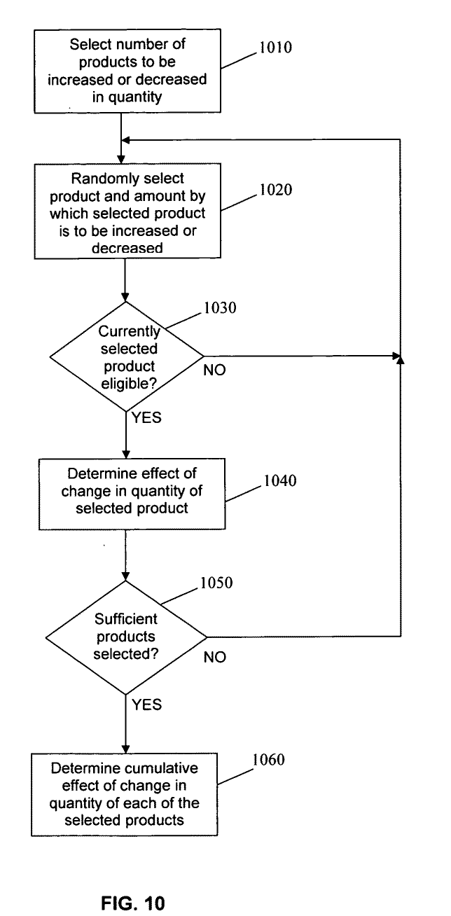

A method is now described hereinafter with reference to FIG. 10 for randomly selecting a set of products and changes in order quantities for those products. In particular, the method of FIG. 10 may be used to practice step 920 of the method described hereinbefore with reference to FIG. 9.

Referring to FIG. 10, the number of candidate products to be increased and decreased in order quantity is selected at step 1010. The amounts (changes) by which the products in the set are to be increased positively or negatively are random and are typically determined based on a simple probability distribution. However, the changes are influenced by the feasibility state of the different constraints. For example, if a majority of the minimum type constraints are infeasible (e.g., the total values, weights and/or volumes are below a minimum constraint), there will be a higher propensity to increase a product's order quantity. This may be accomplished, for example, by setting a ‘ratio’ to a value of
0.75, if the number of constraints where affected product quantities need to increase exceeds the number of constraints where affected product quantities need to decrease;
0.25, if the number of constraints where affected product quantities need to decrease exceeds the number of constraints where affected product quantities need to increase; and
0.5, otherwise.
   The number of products (candidates) for which changes in order quantity are to be made may then be determined by selecting and squaring a uniform random number to produce a highly skewed distribution (e.g., including substantially more values such as 0.1 compared with substantially fewer numbers such as 0.9), and then multiplying the result by the number of products which are free to be changed. This number is typically capped or limited to a predetermined value (e.g., 10 changes) to avoid excessive computation later should a simulated annealing step result in an accepted solution that needs to be further perturbed. The reason for this limit or cap is that perturbation techniques generally employ enumeration approaches, which are very expensive and tend to require computing time proportional to the square of the number of candidate products chosen in the original simulated annealing move. The number of products (candidates) for which changes in quantity are to be made is then multiplied by the applicable ‘ratio’ above, to produce the numbers of candidate products to increase and decrease, as follows:

$$Number of candidate products to increase = total number of candidate products being {changed}^{*} ratio . \\ Number of candidate products to decrease = total number of candidate products being changed - number of candidate products to increase .$$

Occasionally, (e.g., on 1 in 10 occasions), the two values may be flipped (i.e., the number to increase and the number to decrease are swapped) to help avoid the simulated annealing process becoming stuck in a local ‘optimum’ situation.

At step 1020, a product is randomly selected from the set of candidate products and the amount by which the selected product is to be increased or decreased is randomly selected. Product selection may be performed by generating a uniform random number and then creating an index, which is used to select a product from the set. The selection may, however, be biased so that products with EOQ curves having the flattest gradients are selected slightly more often on account of having greater freedom (i.e., less influence on the overall cost result). EOQ curves with higher gradients have more influence and tend to result in solutions at either the minimum or maximum end of their range of EOQ values, and not in the middle of the range. The amount (change) by which the selected product is increased or decreased is randomly selected and is typically determined based on a simple probability distribution.

At decision step 1030, a determination is made whether the currently selected product is ineligible for a change in order quantity. Reasons for ineligibility include, for example, that the currently selected product may already have been varied in quantity in the current iteration and that the currently selected product may have been ‘fixed’ in quantity, as described hereinbefore. Ineligible products that have been ‘fixed’ and products that have been previously selected in the same iteration are discarded and the method reverts to step 1020 for selection of another product. If the currently selected product is eligible for a change in order quantity, the method proceeds to step 1040.

At step 1040, the effect of the change in quantity of the selected product to the total value, weight, volume and/or ordering cost is initially determined by interpolating along the associated EOQ curve using the current ordering quantity and thereby determining the new total cost (made up of the ordering and carrying cost components), the new weight, volume and/or overall order value.

At decision step 1050, a determination is made whether sufficient products have been selected and changed, based on the result of step 1040. A determination may also be made whether a loop counter has been exceeded, in which case a lower number of changes is selected for use. The purpose of the loop counter is to avoid ‘looping’ situations where the randomly generated numbers keep dropping onto the same product(s) and the loop becomes stuck. If insufficient products have been selected and changed (NO), at decision step 1050, the method reverts to step 1020 to randomly select the next candidate product for evaluation. Otherwise, if sufficient products have been selected and changed (YES), at decision step 1050, the method continues at step 1060.

At step 1060, the cumulative effect of the change in quantity of each of the selected products is determined by summing the effects of the change in quantity for each of the selected products, which were determined in step 1040. The new overall total cost, weight, volume and/or overall order value are saved as the new Result C.

### Computer Implemented Embodiment

FIGS. 11A and 11B collectively provide a schematic block diagram of a general purpose computer system 1100, with which embodiments of the present invention can be practiced. Specifically, the computer system 1100 may be programmed to perform the steps of the methods described hereinbefore and particularly those methods described with reference to FIGS. 4, 8, 9 and 10.

As shown in FIG. 11A, the computer system 1100 is formed by a computer module 1101, input devices such as a keyboard 1102, a mouse pointer device 1103, a scanner 1126, a camera 1127, and a microphone 1180, and output devices including a printer 1115, a display device 1114 and loudspeakers 1117. An external Modulator-Demodulator (Modem) transceiver device 216 may be used by the computer module 1101 for communicating to and from a communications network 1120 via a connection 1121. The network 1120 may be a wide-area network (WAN), such as the Internet or a private WAN. Where the connection 1121 is a telephone line, the modem 1116 may be a traditional “dial-up” modem. Alternatively, where the connection 1121 is a high capacity (e.g., cable) connection, the modem 1116 may be a broadband modem. A wireless modem may also be used for wireless connection to the network 1120. The computer module 1101 typically includes at least one processor 1105 and a memory 1106, for example, formed from semiconductor random access memory (RAM) and semiconductor read only memory (ROM). The at least one processor 1105 may comprise multiple processors, for example, arranged in a pipelined or parallel configuration. The module 1101 also includes an number of input/output (I/O) interfaces including an audio-video interface 1107 that couples to the video display 1114, loudspeakers 1117 and microphone 1180, an I/O interface 1113 for the keyboard 1102, mouse 1103, scanner 1126, camera 1127 and optionally a joystick (not illustrated), and an interface 1108 for the external modem 1116 and printer 1115. In some implementations, the modem 1116 may be incorporated within the computer module 1101, for example within the interface 1108. The computer module 1101 also has a local network interface 1111 which, via a connection 1123, permits coupling of the computer system 1100 to a local computer network 1122, known as a Local Area Network (LAN). As also illustrated, the local network 1122 may also couple to the wide network 1120 via a connection 1124, which, would typically include a so-called “firewall” device or device of similar functionality. The interface 1111 may be formed by one or more of an Ethernet™ arrangement, a Bluetooth™ wireless arrangement or an IEEE 802.11 wireless arrangement.

The interfaces 1108 and 1113 may afford either or both of serial and parallel connectivity, the former typically being implemented according to the Universal Serial Bus (USB) standards and having corresponding USB connectors (not illustrated). Storage devices 1109 are provided and typically include a hard disk drive (HDD) 1110. Other storage devices such as a floppy disk drive and a magnetic tape drive (not illustrated) may also be used. An optical disk drive 1112 is typically provided and acts as a non-volatile source of data. Portable memory devices, such as optical disks (e.g., CD-ROM, DVD), USB-RAM, and floppy disks for example may then be used as appropriate sources of data to the system 1100.

The components 1105 to 1113 of the computer module 1101 typically communicate via an interconnected bus 1104 and in a manner which results in a conventional mode of operation of the computer system 1100 known to those skilled in the relevant art. Examples of computers with which the arrangements or embodiments described herein can be practiced include IBM-PCs and compatibles, Sun Sparcstations, Apple Mac™ or similar computer systems.

The methods or processes described hereinbefore may be implemented as software, such as one or more application programs 1133 executable within the computer system 1100. In particular, the steps of the methods or processes described hereinbefore may be implemented as programmed instructions 1131 in the software 1133 that are executed by the computer system 1100. The software instructions 1131 may be formed as one or more code modules, each for performing one or more particular tasks. The software may also be divided into two separate parts, in which a first part and the corresponding code modules performs the methods described herein and a second part and the corresponding code modules manage a user interface between the first part and the user.

The software 1133 is generally loaded into the computer system 1100 from a computer readable medium (the software 1133 and computer readable medium together form a computer program product), and is then typically stored in the HDD 1110, as illustrated in FIG. 11A, or the memory 1106, after which the software 1133 can be executed by the computer system 1100. In some instances, the application programs 1133 may be supplied to the user encoded on one or more CD-ROM 1125 and read via the corresponding drive 1112 prior to storage in the memory 1110 or 1106. Alternatively the software 1133 may be read by the computer system 1100 from the networks 1120 or 1122 or loaded into the computer system 1100 from other computer readable media. A computer readable storage media refers to any storage medium that participates in providing instructions and/or data to the computer system 1100 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external to the computer module 1101. Examples of computer readable transmission media that may also participate in the provision of software, application programs, instructions and/or data to the computer module 1101 include radio or infra-red transmission channels as well as a network connection to another computer or networked device, and the Internet or Intranets including email transmissions and information recorded on Websites and the like.

The second part of the application programs 1133 and the corresponding code modules mentioned above may be executed to implement one or more graphical user interfaces (GUIs) to be rendered or otherwise represented upon the display 1114. Through manipulation of typically the keyboard 1102 and the mouse 1103, a user of the computer system 1100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1117 and user voice commands input via the microphone 1180.

FIG. 11B is a detailed schematic block diagram of the at least one processor 1105 and a “memory” 1134. While only a single processor is shown in FIGS. 11A and 11B, those skilled in the art will appreciate that multiple processors or processor cores may be used to practice embodiments of the present invention. The memory 1134 represents a logical aggregation of all the memory devices (including the HDD 1110 and semiconductor memory 1106) that can be accessed by the computer module 1101 in FIG. 11A.

When the computer module 1101 is initially powered up, a power-on self-test (POST) program 1150 executes. The POST program 1150 is typically stored in a ROM 1149 of the semiconductor memory 1106. A program permanently stored in a hardware device such as the ROM 1149 is sometimes referred to as firmware. The POST program 1150 examines hardware within the computer module 1101 to ensure proper functioning, and typically checks the processor 1105, the memory (1109, 1106), and a basic input-output systems software (BIOS) module 1151, also typically stored in the ROM 1149, for correct operation. Once the POST program 1150 has run successfully, the BIOS 1151 activates the hard disk drive 1110. Activation of the hard disk drive 1110 causes a bootstrap loader program 1152 that is resident on the hard disk drive 1110 to execute via the processor 1105. This loads an operating system 1153 into the RAM memory 1106 upon which the operating system 1153 commences operation. The operating system 1153 is a system level application, executable by the processor 1105, to fulfil various high level functions, including processor management, memory management, device management, storage management, software application interface, and generic user interface.

The operating system 1153 manages the memory 1109, 1106 in order to ensure that each process or application running on the computer module 1101 has sufficient memory in which to execute without colliding with memory allocated to another process. Furthermore, the different types of memory available in the system 1100 must be used properly so that each process can run effectively. Accordingly, the aggregated memory 1134 is not intended to illustrate how particular segments of memory are allocated (unless otherwise stated), but rather to provide a general view of the memory accessible by the computer system 1100 and how such is used.

The processor 1105 includes a number of functional modules including a control unit 1139, an arithmetic logic unit (ALU) 1140, and a local or internal memory 1148, sometimes called a cache memory. The cache memory 1148 typically includes a number of storage registers 244-246 in a register section. One or more internal buses 1141 functionally interconnect these functional modules. The processor 1105 typically also has one or more interfaces 1142 for communicating with external devices via the system bus 1104, using a connection 1118.

The application program 1133 includes a sequence of instructions 1131 that may include conditional branch and loop instructions. The program 1133 may also include data 1132 which is used in execution of the program 1133. The instructions 1131 and the data 1132 are stored in memory locations 1128-1130 and 1135-1137 respectively. Depending upon the relative size of the instructions 1131 and the memory locations 1128-1130, a particular instruction may be stored in a single memory location as depicted by the instruction shown in the memory location 1130. Alternately, an instruction may be segmented into a number of parts each of which is stored in a separate memory location, as depicted by the instruction segments shown in the memory locations 1128-1129.

In general, the processor 1105 is given a set of instructions which are executed therein. The processor 1105 then waits for a subsequent input, to which it reacts to by executing another set of instructions. Each input may be provided from one or more of a number of sources, including data generated by one or more of the input devices 1102, 1103, data received from an external source across one of the networks 1120, 1122, data retrieved from one of the storage devices 1106, 1109 or data retrieved from a storage medium 1125 inserted into the corresponding reader 1112. The execution of a set of the instructions may in some cases result in output of data. Execution may also involve storing data or variables to the memory 1134.

The embodiments disclosed herein may use input variables 1154 that are stored in the memory 1134 in corresponding memory locations 1155-1158. The embodiments disclosed herein may produce output variables 1161 that are stored in the memory 1134 in corresponding memory locations 1162-1165. Intermediate variables may be stored in memory locations 1159, 1160, 1166 and 1167.

The register section 1144-1146, the arithmetic logic unit (ALU) 1140, and the control unit 1139 of the processor 1105 work together to perform sequences of micro-operations needed to perform “fetch, decode, and execute” cycles for every instruction in the instruction set making up the program 1133. Each fetch, decode, and execute cycle comprises:
(a) a fetch operation, which fetches or reads an instruction 1131 from a memory location 1128;
(b) a decode operation in which the control unit 1139 determines which instruction has been fetched; and
(c) an execute operation in which the control unit 1139 and/or the ALU 1140 execute the instruction.

Thereafter, a further fetch, decode, and execute cycle for the next instruction may be executed. Similarly, a store cycle may be performed by which the control unit 1139 stores or writes a value to a memory location 1132.

Each step or sub-process in the methods or processes described herein is associated with one or more segments of the program 1133, and is performed by the register section 1144-1147, the ALU 1140, and the control unit 1139 in the processor 1105 working together to perform the fetch, decode, and execute cycles for every instruction in the instruction set for the noted segments of the program 1133.

The computer system 1100 has been described for illustrative purposes. Accordingly, the foregoing description relates to an example of a particular type of computer system suitable for practising the methods and computer program products described hereinbefore. However, those skilled in the computer programming and other arts relating to the present invention would readily understand that other configurations or types of computer systems can be equally well used to practise the methods and computer program products described hereinbefore.

The embodiments described hereinbefore enable determination or selection of product quantities so as to minimise the overall costs of ordering and carrying inventory, taking into account any cost breaks which might be available for particular order quantities, values, etc. The embodiments described hereinbefore advantageously enable a large range or potential order quantities of a large number of products (potentially across multiple suppliers and multiple warehouses) to be quickly and efficiently evaluated. Furthermore, the embodiments described hereinbefore advantageously enable multiple constraints (e.g., value, weight and volume) to be applied.

Certain embodiments have been described that use the iterative optimisation technique of ‘Simulated Annealing’. However, those skilled in the relevant arts will appreciate that other techniques such as Integer Programming could alternatively be used.

The embodiments hereinbefore have been described with reference to Economic Order Curves (EOQ) Curves. However, the methods and systems of the embodiments described can also be applied to Economic Stocking Quantity (ESQ) Curves. In such instances, rather than determining a near optimal set of order quantities based on a series of constraints which might relate to a minimum order size related to say a rebate target, or a maximum order size relating to the remaining weight and/or volume capacity in a container, the embodiments described hereinbefore can be used to, for example:
recommend stocking quantities for a set of products under constraints such as the maximum weight or volume which can be stored. Such constraints may, for example, apply if a retail outlet had a mezzanine warehouse which had a weight or space limitation, either in the whole or for certain sets of products.
recommend stocking quantities to go in a repair or service van. In this case, total product value constraints relating to a working capital for a franchisee or perhaps a weight limit relating to the fuel consumption and wear on the vehicle may apply.

In these and similar cases, ESQ curves may be generated in a similar way to the procedure for the EOQ curves, except that the x-axis of an ESQ represents inventory level as opposed to ordering level. The y-axis would still represent the total cost but would, in this case, include components such as carrying costs, replenishment costs, estimated costs of emergency stock transfers (when there are lower levels) and estimates of lost sales. In a slight variation, the ‘cost’ could comprise a weighted score based on the service level, profitability and return on assets (ROA). This would enable management to set service level, profitability and ROA objectives and for the inventory levels to be adjusted in line with these. For example, there would be a cost or score for say 100 units as the target inventory level, a slighter higher cost or score (or lower as the case might be) for 110, 120, 130, etc. units of stock.

Once the ESQ curves are generated, the optimisation process would proceed similarly to that described for the EOQ curves, except that, for example, a maximum order volume constraint would be regarded as a maximum inventory volume constraint, etc.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

I claim:

1. A computer-implemented method for determining optimal or near-optimal product order quantities for receipt on one or more predetermined days, said method comprising the steps of:
obtaining inventory data for each of a range of products over a predetermined time period including said one or more predetermined days;
generating and storing a representation of an Economic Order Quantity (EOQ) curve for each of said range of products using said inventory data, each of said EOQ curve representations generated specifically for one of said one or more predetermined days and each comprising a plurality of data sets each including a product order quantity and an associated cost; and
iteratively:
selecting products from said range of products and determining potential order quantities for each of said selected products;
for each selected product, retrieving the cost associated with the determined potential order quantity of said product from a respective stored EOQ curve representation;
determining a total cost for ordering said selected products in said potential order quantities; and
storing the currently selected set of products and associated potential order quantities if said total cost is less than a previously determined total cost.

2. The computer-implemented method of claim 1, comprising the steps of:
randomly selecting a set of products from the range of products and varying potential order quantities of said randomly selected products; and
calculating a new total cost based on the varied order quantities.

3. The computer-implemented method of claim 2, comprising the further step of evaluating the varied order quantities relative to constraints.

4. The computer-implemented method of claim 1, comprising the further steps of:
determining one or more values from the group of values consisting of total order weight, total order volume, and total order value; and
evaluating said one or more determined values against one or more constraints to determine feasibility of said currently selected set of products and associated potential order quantities.

5. The computer-implemented method of claim 1, comprising the further step of interpolating between two of said stored data sets to retrieve the cost associated with the determined potential order quantity of a product from a respective stored EOQ curve representation.

6. A computer-implemented method for generating a representation of costs associated with inventory quantities of a product on a future event day, said method comprising the steps of:
obtaining a projected inventory level of the product for the event day;
generating a daily inventory projection for the product from the event day for a predetermined period;
determining a total cost associated with maintaining said daily inventory projection of the product over the predetermined period, said total cost comprising inventory ordering costs and inventory carrying costs;
determining a first product quantity required to increase the projected inventory level of said product on said event day to a maximum inventory level on said event day;
determining a total cost associated with said first product quantity, said total cost comprising inventory ordering costs and inventory carrying costs;
selecting a first plurality of product quantities between zero and said first product quantity;
selecting a second plurality of product quantities between said first product quantity and a maximum allowable excess inventory for said product;
determining a total cost associated with each of said first and second plurality of product quantities, each said total cost comprising inventory ordering costs and inventory carrying costs; and
storing said total costs associated with each of said first and second plurality of product quantities for later retrieval.

7. The computer-implemented method of claim 6, wherein said step of generating a daily inventory projection for the product from the event day for a predetermined period comprises calculating the product inventory level at the end of each day by adding the quantity of any incoming inventory on the day and subtracting the quantity of any outgoing inventory on the day to/from the opening inventory on the day.

8. The computer-implemented method of claim 6, wherein said inventory carrying costs are determined by determining the average inventory level for the product over the predetermined period and multiplying said average inventory level by a carrying cost rate for the predetermined period.

9. The computer-implemented method of claim 6, wherein said inventory carrying costs are determined by summing the results of multiplying the daily excess inventory by the daily carrying cost rate.

10. The computer-implemented method of claim 6, wherein said first product quantity and said first and second plurality of product quantities comprise product order quantities.

11. A computer system for determining optimal or near-optimal product order quantities for receipt on one or more predetermined days, said computer system comprising:
a memory for storing data for use by one or more processors; and
at least one processor coupled to said memory and programmed to:
retrieve inventory data for each of a range of products over a predetermined time period including said one or more predetermined days;
generate and store a representation of an Economic Order Quantity (EOQ) curve for each of said range of products using said inventory data, each of said EOQ curve representations generated specifically for one of said one or more predetermined days and each comprising a plurality of data sets each including a product order quantity and an associated cost; and
iteratively:
select products from said range of products and determining potential order quantities for each of said selected products;
for each selected product, retrieve the cost associated with the determined potential order quantity of said product from a respective stored EOQ curve representation;
determine a total cost for ordering said selected products in said potential order quantities; and
store the currently selected set of products and associated potential order quantities if said total cost is less than a previously determined total cost.

12. The computer system of claim 11, wherein said at least one processor is programmed to:
randomly select a set of products from the range of products and vary potential order quantities of said randomly selected products; and
calculate a new total cost based on the varied order quantities.

13. The computer system of claim 12, wherein said at least one processor is further programmed to evaluate the varied order quantities relative to constraints.

14. The computer system of claim 11, wherein said at least one processor is further programmed to:
determine one or more values from the group of values consisting of total order weight, total order volume, and total order value; and
evaluate said one or more determined values against one or more constraints to determine feasibility of said currently selected set of products and associated potential order quantities.

15. The computer system of claim 11, wherein said at least one processor is further programmed to interpolate between two of said stored data sets to retrieve the cost associated with the determined potential order quantity of a product from a respective stored EOQ curve representation.

16. A computer system for generating a representation of costs associated with inventory quantities of a product on a future event day, said computer system comprising:
a memory for storing data for use by one or more processors; and
at least one processor coupled to said memory and programmed to:
obtain a projected inventory level of the product for the event day;
generate a daily inventory projection for the product from the event day for a predetermined period;
determine a total cost associated with maintaining said daily inventory projection of the product over the predetermined period, said total cost comprising inventory ordering costs and inventory carrying costs;
determine a first product quantity required to increase the projected inventory level of said product on said event day to a maximum inventory level on said event day;
determine a total cost associated with said first product quantity, said total cost comprising inventory ordering costs and inventory carrying costs;
select a first plurality of product quantities between zero and said first product quantity;
select a second plurality of product quantities between said first product quantity and a maximum allowable excess inventory for said product;
determine a total cost associated with each of said first and second plurality of product quantities, each said total cost comprising inventory ordering costs and inventory carrying costs; and
store said total costs associated with each of said first and second plurality of product quantities for later retrieval.

17. The computer system of claim 16, wherein said step of generating a daily inventory projection for the product from the event day for a predetermined period comprises calculating the product inventory level at the end of each day by adding the quantity of any incoming inventory on the day and subtracting the quantity of any outgoing inventory on the day to/from the opening inventory on the day.

18. The computer system of claim 16, wherein said inventory carrying costs are determined by determining the average inventory level for the product over the predetermined period and multiplying said average inventory level by a carrying cost rate for the predetermined period.

19. The computer system of claim 16, wherein said inventory carrying costs are determined by summing the results of multiplying the daily excess inventory by the daily carrying cost rate.

20. The computer system of claim 16, wherein said first product quantity and said first and second plurality of product quantities comprise product order quantities.

21. A computer program product comprising a computer readable medium comprising a computer program recorded therein for determining optimal or near-optimal product order quantities for receipt on one or more predetermined days, said computer program product comprising:
computer program code means for obtaining inventory data for each of a range of products over a predetermined time period including said one or more predetermined days;
computer program code means for generating and storing a representation of an Economic Order Quantity (EOQ) curve for each of said range of products using said inventory data, each of said EOQ curve representations generated specifically for one of said one or more predetermined days and each comprising a plurality of data sets each including a product order quantity and an associated cost; and
computer program code means for iteratively:
selecting products from said range of products and determining potential order quantities for each of said selected products;
for each selected product, retrieving the cost associated with the determined potential order quantity of said product from a respective stored EOQ curve representation;
determining a total cost for ordering said selected products in said potential order quantities; and
storing the currently selected set of products and associated potential order quantities if said total cost is less than a previously determined total cost.

22. The computer program product of claim 21, comprising:
computer program code means for randomly selecting a set of products from the range of products and varying potential order quantities of said randomly selected products; and
computer program code means for calculating a new total cost based on the varied order quantities.

23. The computer program product of claim 22, further comprising computer program code means for evaluating the varied order quantities relative to constraints.

24. The computer program product of claim 21, further comprising:
computer program code means for determining one or more values from the group of values consisting of total order weight, total order volume, and total order value; and
computer program code means for evaluating said one or more determined values against one or more constraints to determine feasibility of said currently selected set of products and associated potential order quantities.

25. The computer program product of claim 21, further comprising computer program code means for interpolating between two of said stored data sets to retrieve the cost associated with the determined potential order quantity of a product from a respective stored EOQ curve representation.

26. A computer program product comprising a computer readable medium comprising a computer program recorded therein for generating a representation of costs associated with inventory quantities of a product on a future event day, said computer program product comprising:
computer program code means for obtaining a projected inventory level of the product for the event day;
computer program code means for generating a daily inventory projection for the product from the event day for a predetermined period;
computer program code means for determining a total cost associated with maintaining said daily inventory projection of the product over the predetermined period, said total cost comprising inventory ordering costs and inventory carrying costs;
computer program code means for determining a first product quantity required to increase the projected inventory level of said product on said event day to a maximum inventory level on said event day;
computer program code means for determining a total cost associated with said first product quantity, said total cost comprising inventory ordering costs and inventory carrying costs;
computer program code means for selecting a first plurality of product quantities between zero and said first product quantity;
computer program code means for selecting a second plurality of product quantities between said first product quantity and a maximum allowable excess inventory for said product;
computer program code means for determining a total cost associated with each of said first and second plurality of product quantities, each said total cost comprising inventory ordering costs and inventory carrying costs; and
computer program code means for storing said total costs associated with each of said first and second plurality of product quantities for later retrieval.

27. The computer program product of claim 26, wherein said computer program code means for generating a daily inventory projection for the product from the event day for a predetermined period comprises computer program code means for calculating the product inventory level at the end of each day by adding the quantity of any incoming inventory on the day and subtracting the quantity of any outgoing inventory on the day to/from the opening inventory on the day.

28. The computer program product of claim 26, wherein said inventory carrying costs are determined by determining the average inventory level for the product over the predetermined period and multiplying said average inventory level by a carrying cost rate for the predetermined period.

29. The computer program product of claim 26, wherein said inventory carrying costs are determined by summing the results of multiplying the daily excess inventory by the daily carrying cost rate.

30. The computer program product of claim 26, wherein said first product quantity and said first and second plurality of product quantities comprise product order quantities.
